(19) United States
(12) Patent Application Publication
(10) Pub. No.: US 2022/0200704 A1
(43) Pub. Date: Jun. 23, 2022

(54) ALL-OPTICAL MULTI-RATE SYSTEMS AND METHODS

(71) Applicant: Mer-CellO Wireless Solutions LTD., Petah Tikva (IL)

(72) Inventors: Yossef Ben-Ezra, Petah Tikva (IL); Segev Zarkovsky, Tel Aviv (IL)

(21) Appl. No.: 17/603,155

(22) PCT Filed: Apr. 21, 2019
(86) PCT No.: PCT/IB2019/053293

§ 371 Date: Oct. 12, 2021

(51) Int. Cl. H04B 10/516; H04B 10/2513; H04B 10/50; H04J 14/02

(52) U.S. Cl. CPC H04B 10/516; H04J 14/0298; H04B 10/505; H04B 10/2513

(57) ABSTRACT

All-optical multi-rate systems and methods include and use a continuous wave (CW) light source for providing a CW carrier signal, a plurality of modulators used for modulating the CW carrier signal to form a plurality of modulated optical signals, an inverse filter bank for multiplexing the plurality of modulated optical signals to form a multiplexed optical signal, and a post distortion filter (PDF) for obtaining a narrowed multiplexed optical signal and, optionally, for eliminating inter-symbol interference (ISI) in the narrowed multiplexed optical signal.

### CROSS REFERENCE TO RELATED APPLICATIONS

This application is a 371 application from international patent application No. PCT/IB2019/053293 filed Apr. 21, 2019.

### FIELD

Embodiments of various systems disclosed herein relate in general to optical signal processing and more specifically to optical multi-rate signal processing.

### BACKGROUND

Multi-rate digital signal processing systems and methods employ multiple sampling rates for processing of digital signals. Upsampling (interpolation) and downsampling (decimation) are performed to change the sampling rates within the system using, for example, filters and filter banks.

All-analog (such as all-optical, all-RF) implementations of filter bank based multi-rate systems require a pulsed carrier complex envelope, such as a pulsed laser used in an all-optical system. Such a multi-rate system is useful, for example, for an all-optical multiplexing/demultiplexing system based on filter banks. Such an implementation is described by Cincotti (“Optical Wavelet Signals Processing and Multiplexing”, Cincotti, G., Moreolo, M. S. & Neri, A. EURASIP J. Adv. Signal Process. (2005)). In Cincotti the input signal is pulsed and the filter bank is based on cascaded unbalanced MZI (Mach-Zehnder interferometer) filters. The pulsed signal requires a pulsed laser having temporal behaviour gₚ(t) expressed in the time domain as:

$${g}_{p} ( t ) = Π ( \frac{T}{N} ) , {G}_{p} ( ω ) = \frac{1}{j ω} ( 1 - {e}^{- j ω \frac{T}{N}} ) \qquad ( 1 )$$

where:
Gₚ(ω)=Fourier transform of gₚ(t)

$$Π ( \frac{T}{N} ) = window function with width \frac{T}{N} centered around t = 0$$

The use of a pulsed laser significantly increases the cost of implementing such systems, and such systems have therefore found limited use. Further, launching pulses with the required width and repetition rate from a pulsed laser is quite complex.

Use of continuous wavelength (CW) carriers in optical communications is known. A CW carrier c(t) can be represented using the complex envelope:

c(t)=Re{Ae^{jω}^{_{c}}^{t}} (2)

Upon modulation of a CW signal, the resulting modulated signal complex envelope S(t) is represented as:

S(t)=AΣₙaₙg_{cw}(t−nT) (3)

where aₙ are the data symbols, T is the symbol duration and g_{cw}(t) is a function describing the CW carrier shape in the time domain. However, there is no known use of CW carriers in an all-optical multi-rate system, because performing multi-rate operations on a modulated signal from a CW carrier will result in intersymbol interference (ISI) and performance degradation, as exemplified by the following example. In this example, the ISI can be seen as an overlap in the summation below:

Assume that S₁ and S₂ are two consecutive symbols with duration T:

$${S}_{{0}_{1}} ( t ) = \frac{1}{2} ( {S}_{1} ( t ) + {S}_{2} ( t - \frac{T}{2} ) )$$

$${S}_{{0}_{2}} ( t ) = \frac{1}{2} ( {S}_{1} ( t ) - {S}_{2} ( t - \frac{T}{2} ) )$$

As can be seen, an ISI occurs due to the half symbol time delay.

There is therefore a need for, and it would be advantageous to have systems and methods that overcome the ISI to enable implementation of multi-rate systems based on CW carriers.

The description above is presented as a general overview of related art in this field and should not be construed as an admission that any of the information it contains constitutes prior art against the present patent application.

### SUMMARY

Embodiments disclosed herein relate to all-optical multi-rate systems using CW carriers. According to some embodiments, an optical multi-rate system disclosed herein comprises a CW light source for generating a CW carrier signal, an optical splitter, a plurality of modulators used each to modulate the CW carrier signal, an inverse filter bank (or “multiplexer”, a filter bank (or “demultiplexer”) and a post distortion filter (PDF) positioned between the inverse filter bank and the filter bank. For example and in a non-limiting way, the modulation may be PAM4 amplitude modulation. In general, the modulation may be of any known type, for example PAM, QAM (Quadrature Amplitude Modulation), DPSK or OOK. For example, the PAM modulation may be PAM4, PAM8 or higher PAM modulation, and the QAM modulation may be QAM4, QAM8, . . . QAM 64 or higher QAM modulation. For example and in a non-limiting way, the multiplexing may be Wavelet Packet Division Multiplexing (WPDM) based on a CW laser. For example and in a non-limiting way, the filter banks may be wavelet or multi-wavelet filter banks. In general, other types of filter banks may also be used for the all-optical multi-rate signal processing and transmission using CW carriers disclosed herein. The post distortion filter resolves the intersymbol interference that may result from the use of a CW carrier in an all-optical multi-rate system and which can lead to system degradation.

In exemplary embodiments, there are provided systems comprising: a CW light source used for providing a CW carrier signal, a plurality of modulators used for modulating the CW carrier signal to form a plurality of modulated optical signals, an inverse filter bank used for multiplexing the plurality of modulated optical signals to form a multiplexed optical signal, and a post distortion filter (PDF) used for obtaining a narrowed multiplexed optical signal and, optionally, for overcoming or eliminating ISI in the narrowed multiplexed optical signal, wherein the system is an all-optical multi-rate system.

In exemplary embodiments, there are provided methods comprising: using a CW light source to provide a CW carrier signal, using a plurality of modulators to modulate the CW carrier signal to form a plurality of modulated optical signals, using an inverse filter bank to multiplex the plurality of modulated optical signals to form a multiplexed optical signal, and using a post distortion filter (PDF) to obtain a narrowed multiplexed optical signal and, optionally, to eliminate ISI in the narrowed multiplexed optical signal.

In some embodiments, a system further comprises a filter bank used for demultiplexing the narrowed multiplexed optical signal into a plurality of demultiplexed modulated optical signals.

In some embodiments, the inverse filter bank and the filter bank are inverse multiwavelet (IMW) filter bank. In some embodiments, the IMW and MW filter banks are Geronimo, Hardian and Massopust IMW filter banks.

In some embodiments, the PDF comprises a 50/50 beam splitter for splitting the multiplexed optical signal into a first 50/50 splitter output and a second 50/50 splitter output, a first phase shifter for receiving the first 50/50 splitter output and for providing a first phase shifter output, a recombiner for combining the first phase shifter output and the second 50/50 splitter output into a recombiner output, a combiner for combining the recombiner output with a phase shifted feedback signal provided by a second phase shifter to provide a combiner output, an amplifier for amplifying the combiner output to provide an amplifier output, an a beam splitter for splitting the amplifier output into a PDF output signal and a feedback signal provided to the second phase shifter. In some embodiments, the PDF is further used for providing chromatic dispersion compensation.

In some embodiments, the modulators are electro-optical modulators.

In some embodiments, the modulators are Mach-Zehnder modulators.

In some embodiments, a system further comprises a plurality of demodulators for demodulating the plurality of demultiplexed modulated optical signals.

In some embodiments, the plurality of modulated optical signals is equal to 2^{N}, where N is the decomposition level of the inverse filter bank.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

Embodiments disclosed herein are described, by way of example only, with reference to the following accompanying drawings, wherein:

FIG. 1A illustrates in a block diagram and embodiment of an optical transmission system, disclosed herein;

FIG. 1B illustrates in a block diagram details of a post distortion filter in the optical transmission system of FIG. 1A;

FIG. 2A shows a flow-chart of an embodiment of a method for transmission of square symbol signals disclosed herein;

FIG. 2B shows a flow-chart of an embodiment of a method disclosed herein and used for transmission of Gaussian symbol signals disclosed herein;

FIG. 3A shows a graph illustrating a rectangular signal input at point A in FIG. 1A;

FIG. 3B shows a graph illustrating the rectangular signal that is obtained at point B in FIG. 1A without the use of a PDF disclosed herein;

FIG. 3C shows a graph illustrating the rectangular signal that is obtained at point B in FIG. 1A after use of a PDF disclosed herein;

FIG. 4A shows a graph illustrating a Gaussian signal input at point A in FIG. 1A;

FIG. 4B shows a graph illustrating the Gaussian signal that is obtained at point B in FIG. 1A without the use of a PDF disclosed herein;

FIG. 4C shows a graph illustrating the Gaussian signal that is obtained at point B in FIG. 1A after use of a PDF disclosed herein.

### DETAILED DESCRIPTION

To implement a system and method disclosed herein, the constant wave source in eq. (3), g_{cw}(t) must be transformed to that of a pulse shape resulting from a pulsed source gₚ(t). Using linear convolution:

g_{cw}(t)*h(t)=gₚ(t) (4)

where g_{cw}(t) is as in equation 6 below and h(t) represents a post distortion filter (PDF). Using known relationships in the frequency domain, equation (4) can be represented as:

$$H ( j ω ) = \frac{{G}_{p} ( j ω )}{{G}_{c w} ( j ω )} \qquad ( 5 )$$

where H(jω) is a transfer function. g_{cw}(t) is given by

$${g}_{C W} ( t ) = Π ( T ) , {G}_{C W} ( ω ) = \frac{1}{j ω} ( 1 - {e}^{- j ω T} ) \qquad ( 6 )$$

where:
G_{cw}(ω)=Fourier transform of g_{CW}(t)
Π(T)=window function with width T centered around t=0

In a first embodiment, assume that the input signal is a rectangular pulse. Using equations (1) and (6) and inserting into Eq. (5), one obtains

$$H ( j ω ) = \frac{1 - {e}^{- j ω \frac{T}{N}}}{1 - {e}^{- j ω T}} \qquad ( 7 )$$

According to some embodiments, the above transfer function H (jω) is implemented optically by a post distortion filter (PDF), by using a differentiator and an amplifier represented as follows:

$$x ( t ) - x ( t - \frac{T}{N} ) = y ( t ) - y ( t - T ) \qquad ( 8 )$$

where x(t)=input signal to the PDF, y(t)=output signal from the PDF, and N is the ratio between the symbol duration and the pulse duration.

In a second embodiment, it is known that a chirped signal can be narrowed using dispersion management. Assume that the input signal is a Gaussian signal. It can be shown that when g_{cw}(t) is a chirped Gaussian signal

$${g}_{C W} ( t ) = {E}_{0} exp [ - \frac{{t}^{2} ( 1 + j C )}{2 {T}_{0}^{2}} ] \qquad ( 9 )$$

the minimal pulse width is

$${T}_{min} = \frac{{T}_{0}}{\sqrt{1 + {C}^{2}}} \qquad ( 10 )$$

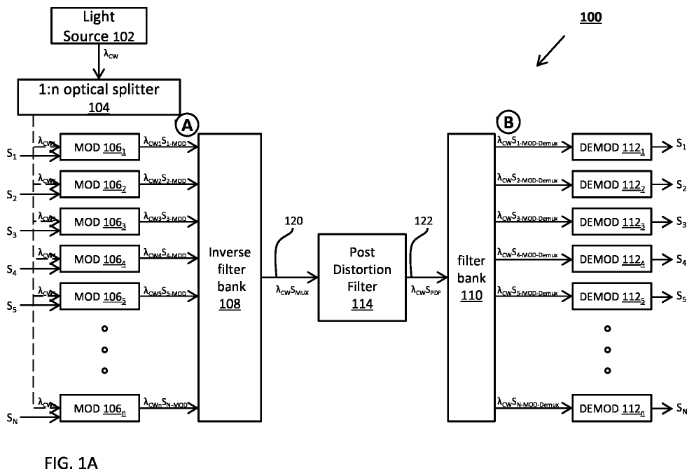

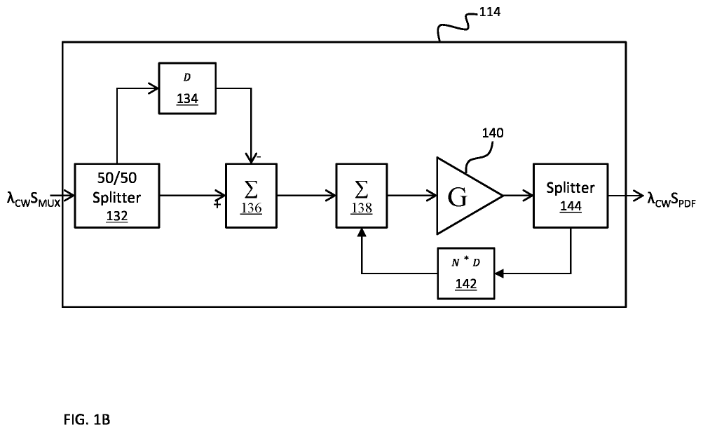

The source electrical data signals are modulated (either by electro-optical (E/O) modulation or by direct modulation) such that chirp is added to the modulated signal for narrowing to the desired line width at the receiver and chromatic dispersion compensation (CDC) is provided by the post distortion filter. The CDC is related to the baud rate and amount of chirp required in a known way. Returning now to the drawings, FIG. 1A illustrates in a block diagram an embodiment numbered 100 of an optical transmission system disclosed herein. Optical transmission system 100 includes a light source 102 (e.g. a CW laser) for generating an unmodulated optical continuous wave carrier. 1:N optical splitter 104, N modulators 106a . . . n, an inverse filter bank (or simply “inverse filter bank”) 108, a filter bank 110, N demodulators 112a . . . n and a post distortion (PDF) filter 114 positioned between inverse filter bank 108 and filter bank 110. In non-limiting examples, inverse filter bank 108 and filter bank 110 may be implemented using wavelet or multiwavelt (MW) filter banks. Such filter banks may be for example Geronimo, Hardian and Massopust (GHM) wavelet or MW filter banks. In general, for optical transform and orthogonal multiplexing of modulated optical signals λ_{CW1}S_{1-MOD}−λ_{CWn}S_{N-MOD}, inverse filter bank 108 and filter bank 110 may be implemented with other types of filter banks that enable these actions, for example cascaded or lattice based directional couplers, or polyphase filters.

Light source 102 is preferably a CW laser i.e. it is not pulsed. Modulators 106 may in some embodiments also be referred to as “external modulators” for being external to light source 102. In some embodiments, modulators 106 may be E/O modulators. In some embodiments, modulators 106 may be Mach-Zehnder modulators (MZM). PDF 114, an exemplary embodiment of which is described in detail with reference to FIG. 1B, may be a separate unit or may be included in, or packaged with inverse filter bank 108 or filter bank 110 in the same package. Packaging of PDF 114 with filter bank 110 enables post distortion filtering after transmission of the optical signal along the length of an optical conduit 122 (see below).

FIG. 1B illustrates in a block diagram details of an exemplary embodiment of PDF 114. In the embodiment shown, PDF 114 comprises a 50/50 beam splitter 132, a first phase shifter 134, a first combiner 136, a second combiner 138, an amplifier 140, a second phase shifter 142 and a beam splitter 144. The function of each component is explained in conjunction with a method of use below.

Optical transmission system 100 may be adapted for transmission of a signal having a rectangular symbol shape or of a signal having a Gaussian symbol shape (also referred to herein as “rectangular signal” and “Gaussian signal”). In use, an unmodulated optical carrier wave λ_{CW} generated by light source 102 is split by splitter 104 into N unmodulated optical carrier waves λ_{CW1}-λ_{CWn}. N source signals S₁-S_{N} are used to modulate the N unmodulated optical carrier waves λ_{CW1}-λ_{CWn} by N modulators 106₁-106ₙ to obtain N modulated optical signals λ_{CW1}S_{1-MOB}-λ_{CWn}S_{N-MOD}. In some embodiments, for multiwavelets, N must be divisible by 2³.

Modulated optical signals having the same carrier wave λ_{CW1}S_{1-MOD}-λ_{CWn}S_{N-MOD} are subjected to (for example) multiwavelet (MW) transformation and filtering by inverse filter bank 108. The resulting processed optical signals are multiplexed or combined into a multiplexed optical output signal λ_{CW}S_{MUX}. The multiplexing is performed by means of optical convolution wherein each data stream is convolved with the appropriate filter coefficients. For example, inverse filter bank 108 may be implemented by (for example) a multiwavelet (e.g. GHM MW) filter bank, as a MW filter bank, by cascaded or lattice based directional couplers, or by polyphase filters.

Inverse filter bank 108 is in optical communication with PDF 114. According to some embodiments, the output of inverse filter bank 108 (signal λ_{CW}S_{MUX}) is coupled into an optical conduit (e.g. waveguide or optical fiber) 120, which inputs it into PDF 114. PDF 114 implements the transfer function (Eq. 8 above):

$$y ( t ) = x ( t ) - x ( t - \frac{T}{N} ) + y ( t - T ) \qquad ( 11 )$$

According to some embodiments, the output of PDF 114 (signal λ_{CW}S_{PDF}) is coupled into an optical conduit (e.g. waveguide or optical fiber) 122.

In use, multiplexed signal λ_{CW}S_{MUX} is input into PDF 114 for convolution with PDF 114. Splitter 132 splits signal λ_{CW}S_{MUX} into two parts, a first part going to first phase shifter 134 and a second part going to first combiner 136. First phase shifter 134 provides a delay of D where:

$$D = \frac{T}{N} \qquad ( 12 )$$

where N is the decomposition level of inverse filter bank 108 as above.

The part of signal λ_{CW}S_{MUX} coming from splitter 132 and the part of signal λ_{CW}S_{MUX} with delay D coming from first phase shifter 134 are recombined in first combiner 136. The recombined signal is fed into combiner 138. The output of combiner 138 is fed into amplifier 140 which amplifies it and outputs and amplifies signal to splitter 144. Splitter 144 returns a first part of the amplified signal to second phase shifter 142. Second phase shifter 142 provides a delay of T as follows:

$$N \times D = \frac{T}{N} N = T \qquad ( 13 )$$

The gain of amplifier 140 and the splitting ratio of splitter 144 are optionally altered depending on the desired performance of PDF 114, i.e. a split resulting in a higher amplitude output from PDF 114 or a lower amplitude output from PDF 114. When a smaller first part of the amplified signal (larger output from PDF 114) is fed back from splitter 144 via second phase shifter 142, more gain is needed in amplifier 140. Conversely, when a larger first part of the amplified signal (smaller output from PDF 114) is fed back from splitter 144 via second phase shifter 142, less gain is needed in amplifier 140.

To summarize, for a square pulse, an input signal λ_{CW}S_{MUX} of width T is transformed by PDF 114 into an output (filtered multiplexed) signal λ_{CW}S_{PDF} of width T/N.

Filtered multiplexed signal λ_{CW}S_{PDF} is transmitted from PDF 114 to filter bank 110 for demultiplexing to provide N demultiplexed signals λ_{CW}S_{1-MOD-Demux} to λ_{CW}S_{N-MOD-Demux}·λ_{CW}S_{PDF} is subjected to (for example) MW transformation and filtering by filter bank 110. The outputs of filter bank 110 are demultiplexed modulated optical signals λ_{CW}S_{1-MOD-Demux} to λ_{CW}S_{N-MOD-Demux}. Exemplarily, filter bank 110 may be realized by either cascaded or lattice based directional couplers. For example, filter bank 110 may be implemented by a multiwavelet (e.g. GHM MW) filter bank, as a MW filter bank, by cascaded or lattice based directional couplers, or by polyphase filters.

The original N source signals S₁-S_{N} are recovered from λ_{CW}S_{1-MOD-Demux} to λ_{CW}S_{N-MOD-Demux} by N demodulators 112₁-112ₙ. In some embodiments, demodulators 112 may be EO demodulators. In some embodiments, demodulators 112 may be Mach-Zehnder demodulators.

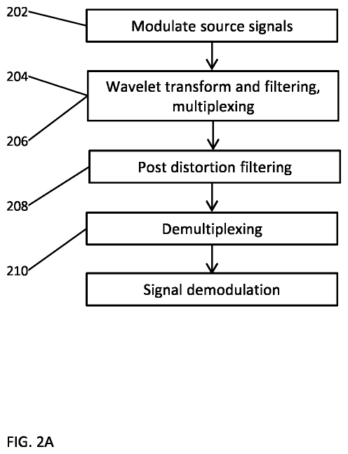

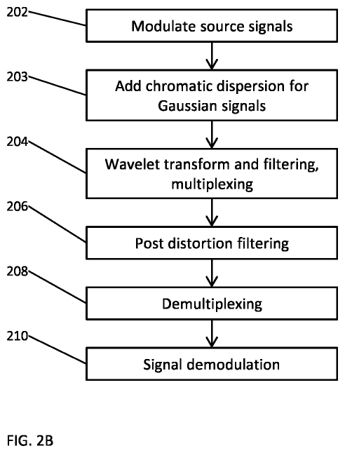

FIGS. 2A and 2B summarize the main steps in some embodiments of methods of use of system 100.

FIG. 2A shows a flow-chart of an embodiment of a method for transmission of square symbol signals. In step 202, a CW is split into unmodulated optical carrier waves λ_{CW1}-λ_{CWn} which are modulated to obtain modulated optical signals. In step 204, the modulated optical signals are input into inverse filter bank 108 where they undergo multiwavelet and filtering. The resulting wavelet-processed optical signals are multiplexed or combined into a multiplexed optical output signal. In step 206, the multiplexed optical signal is passed through a PDF 114 to obtain a filtered signal. In step 208, the filtered signal is input into filter bank 110 where it is demultiplexed into the plurality of modulated signals. In step 210, the demultiplexed modulated signals are demodulated by demodulators 112.

FIG. 2B shows a flow-chart of an embodiment of a method disclosed herein and used for transmission of a signal with chirp management, for example a Gaussian signal. The various steps are as in FIG. 2A, except that and additional step 203 is added between steps 302 and 304. In step 203, chromatic dispersion compensation (CDC) is provided by PDF 114 to the signal at point B in order to narrow a chirped pulse. The signal at point B is narrowed formed by modulating the electrical data signals (either by E/O modulation or by direct modulation). The chirp may be introduced for example (and without being limiting) at light source 142 or at modulators 146. Note that there may be other ways to introduce chirp.

### Method of Use for Square Signal Input

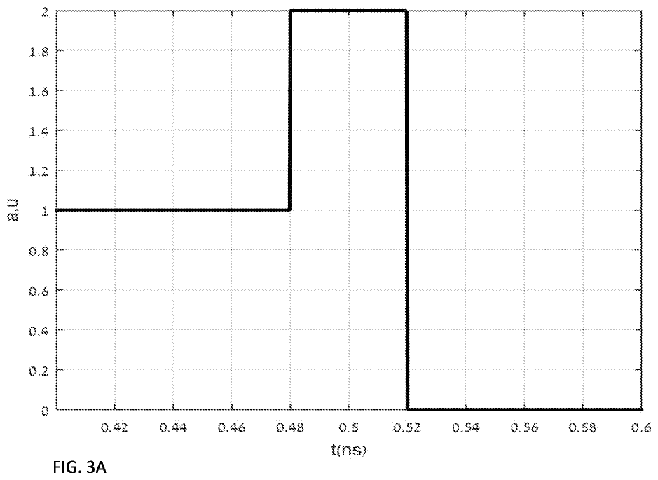

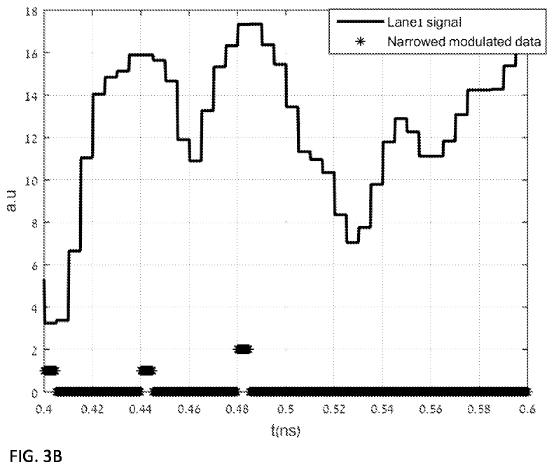

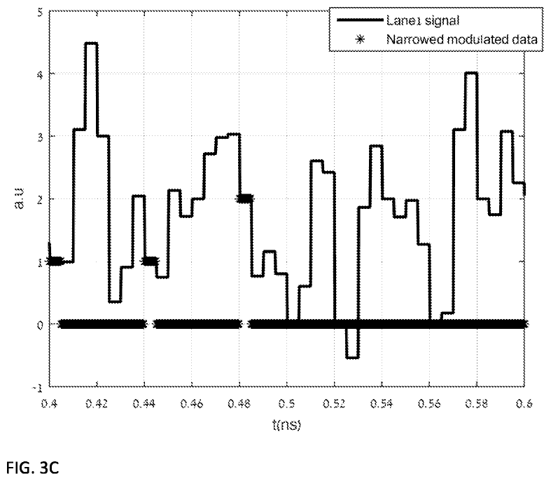

Reference is now made to FIGS. 3A-3D, which show a rectangular signal transmitted through optical transmission system 100 at different points. The data is pulsed for 25 Gbaud, i.e. the width of a single pulse is 0.04 ns. FIG. 3A shows the rectangular signal before it input into inverse filter bank 108 at point A. FIGS. 3B and 3C show a comparison of the rectangular signal shape at point C without being passed through (or after use of) PDF 114 (FIG. 3B) and after being passed through (use of) PDF 114 (FIG. 3C). The “Lane 1 signal” is the signal from point A in FIG. 1 after passing through components inverse filter bank 108, PDF 114 and filter bank 110 and as seen at point B. The “narrow modulated data” is the signal from point A in FIG. 1 after passing through only PDF 114 and as seen at point B.

In FIG. 3A, data shown is in the form of [1, 1, 2, 0, 0] at respectively 0.42, 0.46, 0.5, 0.54 and 0.58 ns. It is generally known that in order to digitize the signal, the signal needs to be sampled at a sampling rate of (in this case) 25 GHertz. Without a PDF (FIG. 3B), one can see that the sampling of the signal does not yield the data (i.e. it is impossible to recover the data). With a PDF (FIG. 3C), one can see that see that the sampling of the signal yields the data exactly.

Method of Use for Gaussian Signal Input with Chirp

In use with a Gaussian-shaped signal, chirp can be added to narrow the signal output to a received to a desired line width.

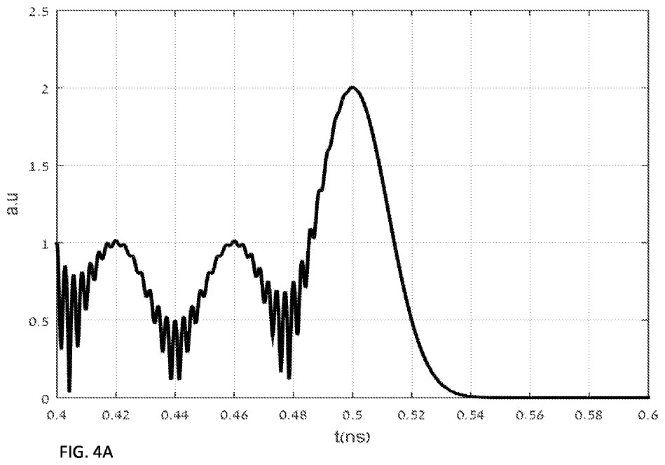

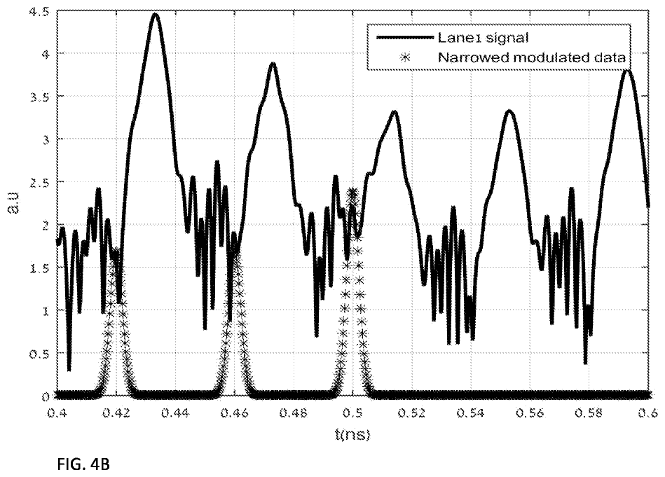

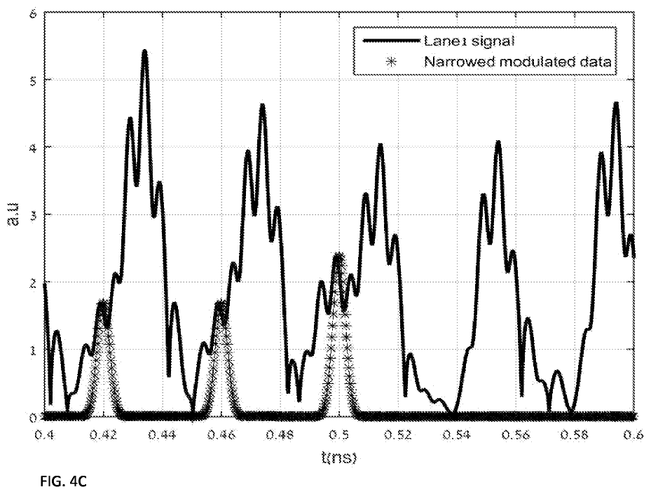

Reference is now made to FIGS. 4A-4D, which show a Gaussian signal transmitted through optical transmission system 100 at different points. FIG. 4A shows the Gaussian signal before it input into inverse filter bank 108 at point A. One sees that the input data is [1, 1, 2, 0, 0] at respectively 0.42, 0.46, 0.5, 0.54 and 0.58 ns. FIGS. 4B and 4C shows a comparison of the Gaussian signal shape at point B without being passed through (or after use of) PDF 114 (FIG. 4B) and after being passed through (use of) PDF 114 (FIG. 4C). As in FIGS. 3B and C, the “Lane 1 signal” is the signal from point A in FIG. 1 after passing through components inverse filter bank 108, PDF 114 and filter bank 110 and as seen at point B, and the “narrow modulated data” is the signal from point A in FIG. 1 after passing through onlt PDF 114 and as seen at point B. One can see that without a PDF (FIG. 4B), the sampling of the signal does not yield the data (i.e. it is impossible to recover the data). With a PDF (FIG. 4C), one can see that see that the sampling of the signal yields the data exactly. One can also see the ISI proble (FIG. 4B) and its solution (FIG. 4C). For example, in FIG. 4B one cannot detect (see) the [0,0] data at 0.54 ns and 0.58 ns. In contrast, these data points can clearly be seen in FIG. 4C.

In the claims or specification of the present application, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended.

It should be understood that where the claims or specification refer to “a” or “an” element, such reference is not to be construed as there being only one of that element.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

While this disclosure describes a limited number of embodiments, it will be appreciated that many variations, modifications and other applications of such embodiments may be made. The disclosure is to be understood as not limited by the specific embodiments described herein, but only by the scope of the appended claims.

1. A system, comprising:
a) a continuous wave (CW) light source used for providing a CW carrier signal;
b) a plurality of modulators used for modulating the CW carrier signal to form a plurality of modulated optical signals;
c) an inverse filter bank used for multiplexing the plurality of modulated optical signals to form a multiplexed optical signal; and
d) a post distortion filter (PDF) used for obtaining a narrowed multiplexed optical signal and, optionally, for eliminating inter-symbol interference (ISI) in the narrowed multiplexed optical signal,
wherein the system is an all-optical multi-rate system.

2. The system of claim 1, further comprising a filter bank used for demultiplexing the narrowed multiplexed optical signal into a plurality of demultiplexed modulated optical signals.

3. The system of claim 1, wherein the inverse filter bank is an inverse multi (IMW) filter bank.

4. The system of claim 1, wherein the filter bank is a multiwavelet (MW) filter bank.

5. The system of claim 1, wherein the PDF comprises:
a 50/50 beam splitter for splitting the multiplexed optical signal into a first 50/50 splitter output and a second 50/50 splitter output,
a first phase shifter for receiving the first 50/50 splitter output and for providing a first phase shifter output,
a recombiner for combining the first phase shifter output and the second 50/50 splitter output into a recombiner output,
a combiner for combining the recombiner output with a phase shifted feedback signal provided by a second phase shifter to provide a combiner output,
an amplifier for amplifying the combiner output to provide an amplifier output, and
a beam splitter for splitting the amplifier output into a PDF output signal and a feedback signal provided to the second phase shifter.

6. The system of claim 1, wherein the modulators are electro-optical modulators.

7. The system of claim 1, wherein the modulators are Mach-Zehnder modulators.

8. The system of claim 2, further comprising a plurality of demodulators used for demodulating the plurality of demultiplexed modulated optical signals.

9. The system of claim 1, wherein the PDF is further used for providing chromatic dispersion compensation.

10. The system of claim 1, wherein the plurality of modulated optical signals is equal to 2^{N}, where N is the decomposition level of the inverse filter bank.

11. The system of claim 3, wherein the IMW filter bank is a Geronimo, Hardian and Massopust IMW filter bank.

12. The system of claim 4, wherein the MW filter bank is a Geronimo, Hardian and Massopust MW filter bank.

13. A method, comprising:
a) using a continuous wave (CW) light source to provide a CW carrier signal;
b) using a plurality of modulators to modulate the CW carrier signal to form a plurality of modulated optical signals;
c) using an inverse filter bank to multiplex the plurality of modulated optical signals to form a multiplexed optical signal; and
d) using a post distortion filter (PDF) to obtain a narrowed multiplexed optical signal and, optionally, to eliminate inter-symbol interference (ISI) in the narrowed multiplexed optical signal.

14. The method of claim 13, further comprising using a filter bank to demultiplex the narrowed multiplexed optical signal into a plurality of demultiplexed modulated optical signals.

15. The method of claim 14, further comprising using a plurality of demodulators to demodulate the plurality of demultiplexed modulated optical signals.

16. The method of claim 13, wherein the using an inverse filter bank to multiplex the plurality of modulated optical signals to form a multiplexed optical signal includes using a multiwavelet inverse filter bank to multiplex the plurality of modulated optical signals to form the multiplexed optical signal.

17. The method of claim 14, wherein the using a filter bank to demultiplex the narrowed multiplexed optical signal into a plurality of demultiplexed modulated optical signals includes using a multiwavelet filter bank to demultiplex the narrowed multiplexed optical signal.

18. A post distortion filter (PDF) for obtaining a narrowed multiplexed optical signal, comprising:
a) a 50/50 beam splitter for splitting the multiplexed optical signal into a first 50/50 splitter output and a second 50/50 splitter output;
b) a first phase shifter for receiving the first 50/50 splitter output and for providing a first phase shifter output;
c) a recombiner for combining the first phase shifter output and the second 50/50 splitter output into a recombiner output;
d) a combiner for combining the recombiner output with a phase shifted feedback signal provided by a second phase shifter to provide a combiner output;
e) an amplifier for amplifying the combiner output to provide an amplifier output; and
f) a beam splitter for splitting the amplifier output into a PDF output signal and a feedback signal provided to the second phase shifter,
wherein the PDF may also optionally be used to eliminate inter-symbol interference (ISI) in the narrowed multiplexed optical signal.
